(19) United States
(12) Patent Application Publication
(10) Pub. No.: US 2009/0070988 A1
(43) Pub. Date: Mar. 19, 2009

(54) Process of producing nonaqueous secondary battery

(76) Inventors: Hitohiko Honda, Saitama (JP); Kiyotaka Yasuda, Saitama (JP); Yoshiki Sakaguchi, Saitama (JP)

Correspondence Address: YOUNG & THOMPSON, 209 Madison Street, Suite 500, ALEXANDRIA, VA, 22314, US

(21) Appl. No.: 11/920,646

(22) PCT Filed: Dec. 8, 2005
(86) PCT No.: PCT/JP2005/022580

§ 371 Date: Nov. 19, 2007

(30) Foreign Application Priority Data
May 17, 2005 (JP) 2005-143622

(51) Int. Cl. H01M 10/04

(52) U.S. Cl. 29/623.1

(57) ABSTRACT

A process of producing a nonaqueous secondary battery comprising the steps of disposing a separator between a member containing a silicon-based material and a positive electrode, together with interposing a metallic lithium layer between the separator and the member to obtain an assembly, and aging the resulting assembly for a prescribed period of time to alloy lithium with the silicon-based material. Lithium alloying is preferably performed to a degree such that the amount of lithium in the silicon-based material is 5% to 50% based on the theoretical initial charge capacity of silicon. When the positive electrode has a lithium-containing active material for positive electrode, lithium alloying is preferably performed to a degree satisfying formula (1): 4.4A−B≧C, where A is the number of moles of silicon in the member containing the silicon-based material; B is the number of moles of lithium in the lithium-containing active material for positive electrode; and C is the number of moles of lithium to be alloyed.

### TECHNICAL FIELD

This invention relates to a process of producing nonaqueous secondary batteries exemplified by lithium secondary batteries.

### BACKGROUND ART

Negative electrodes prepared by coating an active material mixture containing a carbonaceous material such as graphite to a current collector such as copper foil are widely used in lithium secondary batteries. The latest carbonaceous materials have achieved an approximately theoretical level of lithium alloying performance. To obtain a further increased capacity of lithium secondary batteries, development of a class of novel negative electrode materials has been required. Silicon-based materials and tin-based materials have recently been proposed as candidates of such a negative electrode active material.

For example, using silicon particles having lithium alloyed therewith through electrochemical reaction as a negative electrode active material is proposed in contemplation to provide a lithium secondary battery having high voltage, high energy density, and excellent high-rate charge/discharge cycle characteristics (see, for example, U.S. Pat. No. 5,556,721). The silicon particles are pressed into a pellet, and lithium foil is press-bonded thereto to make a negative electrode. The negative electrode is assembled into a battery configuration, and a local cell reaction is induced between lithium and silicon particles in the presence of a nonaqueous electrolyte to cause the silicon particles to alloyed lithium therewith. However, the negative electrode proposed has a drawback that the silicon particles are pulverized by the stress ascribed to expansion and shrink accompanying charge/discharge cycles. The pulverized silicon particles will fall off the negative electrode. The negative electrode also suffers a problem of considerable curl.

### DISCLOSURE OF THE INVENTION

The present invention provides a process of producing a nonaqueous secondary battery. The process comprises the steps of disposing a separator between a member containing a silicon-based material and a positive electrode, together with interposing a metallic lithium layer between the separator and the member to obtain an assembly, and aging the resulting assembly for a prescribed period of time to alloy lithium with the silicon-based material.

### BRIEF DESCRIPTION OF THE ACCOMPANYING DRAWING

FIG. 1 is a schematic illustration of a nonaqueous secondary battery produced in accordance with a preferred embodiment of the process of the present invention.

FIG. 2(a), FIG. 2(b), and FIG. 2(c) each represent a processing step in the preparation of a negative electrode precursor.

FIG. 3 schematically illustrates a preferred embodiment of the process of the invention.

FIG. 4 is a graph showing the second charge/discharge cycle curve of a secondary battery using each of the negative electrodes obtained in Example and Comparative Examples.

### BEST MODE FOR CARRYING OUT THE INVENTION

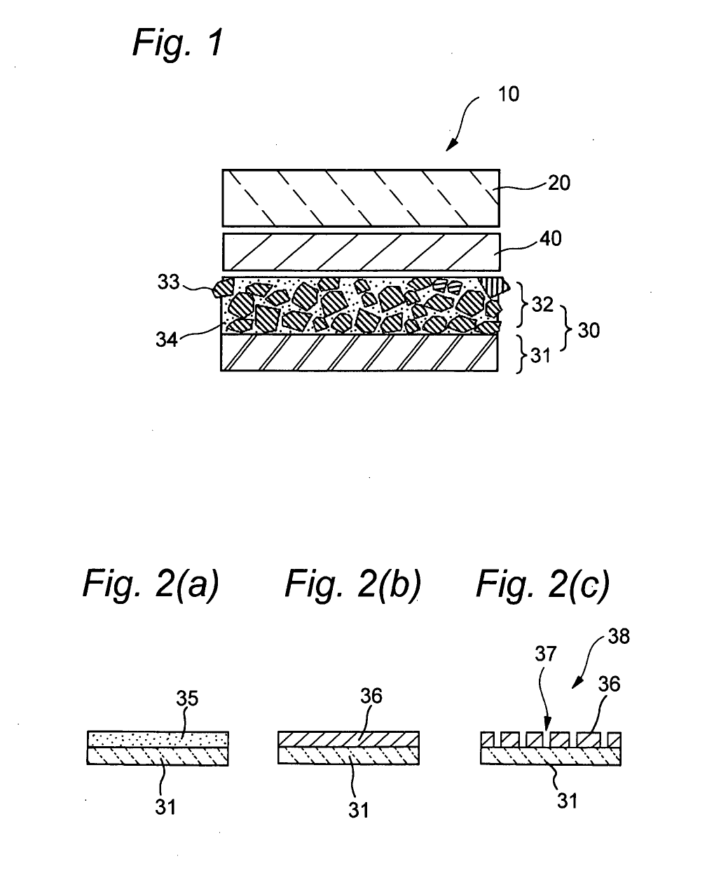

The present invention will be described based on its preferred embodiment with reference to the accompanying drawing. FIG. 1 schematically illustrates a nonaqueous secondary battery produced in accordance with a preferred embodiment of the process of the invention. The battery 10 of the present embodiment has a positive electrode 20 and a negative electrode 30, which face each other with a separator 40 therebetween. The space between the positive and negative electrodes is filled with a nonaqueous electrolyte.

The positive electrode 20 is, for example, one obtained by coating a mixture of active materials for positive electrode to one side of a current collector and, after drying, rolling or pressing the active material mixture. The mixture of active materials for positive electrode is prepared by dispersing an active material for positive electrode and, if necessary, an electroconductive material and a binder in an appropriate solvent. Conventional active materials for positive electrode, including lithium nickel oxide, lithium manganese oxide, and lithium cobalt oxide, can be used. Examples of the separator 40 include nonwoven fabrics made of synthetic resins, porous polyethylene film, and porous polypropylene film. The nonaqueous electrolyte is a solution of a lithium salt as a supporting electrolyte salt in an organic solvent. Examples of the lithium salt include LiClO₄, LiAlCl₄, LiPF₆, LiAsF₆, LiSbF₆, LiSCN, LiCl, LiBr, LiI, LiCF₃SO₃, LiC₄F₉SO₃, and LiBF₄.

The negative electrode 30 has a current collector 31 and an active material layer 32 provided on one side of the current collector 31. The active material layer 32 contains powders of silicon-based material 33 (hereinafter sometimes referred to as particles 33) having lithium alloyed therewith. The active material layer 32 has a metallic material 34 which has low capability of forming a lithium compound and is present between the particles 33. The expression “low capability of forming a lithium compound” as used herein means no capability of forming an intermetallic compound or a solid solution with lithium or, if any, the capability is such that the resulting lithium compound contains only a trace amount of lithium or is very unstable. It is preferred that the metallic material 34 be present through the whole thickness of the active material layer 32 and that the particles 33 be present among the penetrating metallic material 34. In other words, the particles 33 are preferably embedded in the metallic material 34 whereby they are prevented from falling off. Electron conductivity between the current collector 31 and the particles 33 is secured by the metallic material 34 present throughout the active material layer 32. Therefore, occurrence of an electrically isolated particle 33 is prevented effectively. The current collecting function is thus maintained. As a result, reduction in function as a negative electrode is suppressed, and the electrode life is prolonged.

The metallic material 34 having low capability of forming a lithium compound that is present in the active material layer 32 preferably is present throughout in the thickness direction of the active material layer 32, so that the electrical connection between the particles 33 and the current collector 31 via the metallic material 34 is further ensured, and the negative electrode exhibits further enhanced electron conductivity as a whole. The fact that the metallic material 34 is present throughout in the whole thickness of the active material layer 32 can be confirmed by mapping the metallic material 34 using an electron microscope. The metallic material 34 is allowed to be present between the particles 33 by the technique of electroplating. The details of the method for allowing the metallic material 34 to be present between the particles by electroplating are described in commonly assigned U.S. patent application Ser. No. 10/522,791 and corresponding JP 3612669B1.

It is preferred that the interstices between the individual particles 33 in the active material layer 32 be not fully filled with the metallic material 34 having low capability of forming a lithium compound but leave voids. The voids serve to relax or absorb the stress resulting from volumetric changes of the active material particles 33 accompanying charge and discharge cycles. The voids also help a nonaqueous electrolyte to sufficiently impregnate the active material layer 32 throughout the thickness. From this viewpoint, the proportion of the voids in the active material layer 32 is preferably about 0.1% to 30% by volume, still preferably about 0.5% to 5% by volume. The proportion of the voids is obtained through mapping under an electron microscope. Because the active material layer 32 is preferably formed by coating a slurry containing the particles 33 followed by drying, the voids are automatically formed in the active material layer 32. Accordingly, the proportion of the voids can be controlled within the recited range by properly selecting, for example, the particle size of the particles 33, the composition of the electroconductive slurry, and the coating condition of the slurry. It is also possible to adjust the proportion of the voids by pressing the coating layer formed by coating and drying the slurry under proper conditions. It should be noted that the volume of the voids discussed here does not include the volume of holes (through-holes) described later. The active material layer 32 may be formed by gas deposition hereinafter described instead of the method using a slurry containing the particles 33.

The particles 33 are made of silicon-based materials including pure silicon, compounds of silicon and a metal, and silicon oxides. These materials can be used either individually or in combination thereof. The metal is at least one element selected from the group consisting of Cu, Ag, Ni, Co, Cr, Fe, Ti, Pt, W, Mo, and Au. Among them preferred are Cu, Ag, Ni, and Co. It is particularly desirable to use Cu, Ag or Ni for their excellent electron conductivity and low capability of forming a lithium compound.

The metallic material 34 that has low capability of forming a lithium compound and is present in the active material layer 32 has electroconductivity. Examples of such a metallic material include copper, nickel, iron, cobalt, and alloys of these metals.

While the size of the particles 33 is not critical in the present embodiment, it is preferred that the maximum diameter be in the range of from 0.01 to 30 μm, still preferably 0.01 to 10 μm, in view of prevention of the particles 33 from falling off the active material layer 32. For the same reason, the D₅₀ of the particles 33 is preferably in the range of from 0.1 to 8 μm, still preferably 0.3 to 3 μm. The particle size of the particles 33 can be measured by the laser diffraction-scattering method or electron microscopic observation.

The thickness of the active material layer 32 is adjusted as appropriate to the proportion of the particles 33 in the negative electrode 30 and the particle size of the particles 33. While not particularly critical in the present embodiment, the thickness is usually about 1 to 100 μm, preferably about 3 to 60 μm.

Any current collector conventionally used in a negative electrode for nonaqueous secondary batteries can be used as the current collector 31. The current collector is preferably made of the above-described metallic material having low capability of forming a lithium compound, examples of which are given supra. Current collectors made of copper, nickel or stainless steel are particularly preferred. While not critical in the present embodiment, the thickness of the current collector 31 is preferably 10 to 30 μm in view of the balance between retention of strength of the negative electrode 30 and improvement of energy density.

It is preferred that the negative electrode 30 have a large number of holes (not illustrated) open on each surface thereof and extending in the thickness direction of the active material layer 32. The active material layer 32 is exposed on the inner wall of the holes. The holes play the following roles.

One role is to supply a nonaqueous electrolyte to the inside of the active material layer 32 through the surface of the active material layer 32 exposed on the hole walls. Although the active material layer 32 is exposed on the hole walls, the particles 33 are prevented from falling off because the metallic material 34 having low capability of forming a lithium compound is present between the particles 33.

Another role is to relax the stress resulting from volumetric changes of the particles 33 in the active material layer 32 accompanying charge and discharge cycles. The stress is mostly generated along planar directions of the negative electrode 30. Even when the particles 33 increase in volume as a result of charging to generate a stress, the stress will be absorbed by the holes, vacant spaces. Noticeable deformation of the negative electrode 30 is thus avoided effectively

Still another role of the holes is to let out gas generated in the negative electrode 30. Gases, such as H₂, CO and CO₂, can derive from a trace amount of water present in the negative electrode 30. Accumulation of such gases within the negative electrode 30 results in increased polarization, which can cause a loss of charge/discharge capacity. Since the holes allow the gas to escape, polarization due to the gas can be minimized. Yet another role of the holes is radiation of heat for the negative electrode 30. The existence of the holes increases the specific surface area of the negative electrode 30, so that the heat accompanying lithium alloying is efficiently released outside the negative electrode. Heat can also be generated as a result of stress accompanying the volumetric changes of the particles 33. Since the holes absorb the stress, the stress-induced heat generation per se is suppressed.

In order to sufficiently supply the electrolyte to the inside of the active material layer 32 and to effectively relax the stress resulting from the volume changes of the particles 33, it is preferred that the opening holes on the surface of the negative electrode 30 have an open area ratio of 0.3% to 30%, particularly 2% to 15%, the open area ratio being defined to be a percentage of the total area of the openings to the apparent area of the surface of the negative electrode 30. For the same purposes, the opening holes on the surface of the negative electrode 30 preferably have an opening diameter of 5 to 500 μm, still preferably 20 to 100 μm. The pitch of the holes is preferably 20 to 600 μm, more preferably 45 to 400 μm, so as to sufficiently supply the electrolyte into the active material layer and to effectively relax the stress due to the volumetric changes of the particles 33. It is preferred for the surface of the negative electrode 30 to have 100 to 250,000 holes, still preferably 1,000 to 40,000 holes, even still preferably 5,000 to 20,000 holes in average in every 1 cm square field of view.

The holes may penetrate through the whole thickness of the negative electrode 30. Nevertheless, the holes do not need to penetrate through the thickness of the negative electrode 30 in the light of their roles in sufficiently supplying an electrolyte into the active material layer and relaxing the stress due to volumetric change of the particles 33. To perform these roles, it is only necessary for the holes to be open on the surface of the negative electrode 30 and to extend at least in the thickness direction of the active material layer 32.

The negative electrode 30 may have a thin surface layer (not shown) continuously covering the surface of the active material layer 32. The surface layer is preferably made of a metallic material having low capability of forming a lithium compound. The same material as the metallic material 34 being present in the active material layer 32 may be used to form the surface layer. The metallic material may be of the same or different kind from that present in the active material layer 32. The primary role of the surface layer is to prevent fall-off of the particles 33 of the active material layer 32 having been pulverized by the stress accompanying charge/discharge cycles.

The thickness of the surface layer is preferably as small as about 0.3 to 10 μm, still preferably about 0.4 to 8 μm, even still preferably about 0.5 to 5 μm. Such a necessity minimum thickness of the surface layer can achieve substantially continuously coating of the active material layer 32. Fall-off of the pulverized particles 33 can thus be prevented. As far as the surface layer is so thin, the proportion of the particles 33 in the negative electrode can be maintained relatively high, securing an increased energy density per unit volume and unit weight.

It is preferred that the surface layer have a great number of microvoids (not shown) that are open on the surface of the surface layer and lead to the active material layer 32. The microvoids exist in the surface layer, extending in the thickness direction. The microvoids allow a nonaqueous electrolyte to sufficiently impregnate the active material layer 32 and to sufficiently react with the particles 33. In a cross-section of the surface layer, the microvoids have a width of about 0.1 μm to about 10 μm. The microvoids are so fine and yet wide enough to allow impregnation with a nonaqueous electrolyte. In particular, a nonaqueous electrolyte, which has a smaller surface tension than an aqueous one, is capable of infiltrating through the microvoids with a small width.

The process of producing the battery 10 having the above described structure will then be described. A member containing a silicon-based material that becomes a negative electrode 30 is prepared beforehand. The member will hereinafter be referred to as a negative electrode precursor. The negative electrode precursor has the same basic structure as the negative electrode 30 of the battery 10 illustrated in FIG. 1 except is that the particles 33 are silicon-based particles not having lithium alloyed therewith. In the present embodiment, a negative electrode is prepared from the negative electrode precursor as described infra and the precursor itself is not used as a negative electrode. It is possible, nevertheless, to employ the precursor per se as a negative electrode as taught in commonly assigned U.S. patent application Ser. No. 10/522,791 and corresponding JP 3612669B1. The negative electrode precursor is prepared as illustrated in FIGS. 2(a) to 2(c).

As illustrated in FIG. 2(a), a slurry containing powders of silicon-based material is applied to a current collector 31 to form a coating layer 35. The silicon-based material has no lithium alloyed therewith. The slurry contains a particulate electroconductive carbon material, a binder, and a diluent solvent in addition to the particulate silicon-based material. Useful binders include polyvinylidene fluoride (PVDF), polyethylene (PE), ethylene-propylene-diene monomer (EPDM), and styrene-butadiene rubber (SBR). Useful diluting solvents include N-methylpyrrolidone and cyclohexane. In the slurry, the preferable content of the particulate silicon-based material is about 14% to 40% by weight, that of the particulate electroconductive carbon material is about 0.4% to 4% by weight, and that of the binder is about 0.4% to 4% by weight. A diluting solvent is added to a mixture of these materials to prepare the slurry.

A gas deposition method may be used to form a particulate silicon-based material-containing layer on the current collector 31 instead of the slurry application method. The gas deposition method is carried out by mixing active material particles (e.g., Si) with a carrier gas (e.g., nitrogen or argon) in a vacuum chamber to form an aerosol flow, which is jetted from a nozzle onto a substrate (current collecting foil) to deposit a film on the substrate. Allowing for film formation at ambient temperature, the gas deposition method provides a coating layer with less variation in composition, even in using multi-component active material particles as compared with other thin film formation techniques such as CVD, PVD, and sputtering. The gas deposition method also provides an active material layer having a number of voids by adjusting aerosol jetting conditions, such as the particle size of the active material and the gas pressure.

The current collector 31 with the coating layer 35 is then immersed in a plating bath containing a metallic material having low capability of forming a lithium compound to conduct electroplating. Because the coating layer 35 has numerous fine interstices between the particles, on immersing the coating layer 35 in the plating bath, the plating bath penetrates into the interstices and reaches the interface between the coating layer 35 and the current collector 31. In this state, electroplating is conducted (this process will hereinafter be sometimes called penetration plating). As a result, the metallic material having low capability of forming a lithium compound is deposited (a) in the inside of the coating layer 35 and (b) on the inner surface (the surface in contact with the current collector 31) of the coating layer 35 and thereby becomes present in the whole thickness of the coating layer 35. Thus, a plating layer 36 having the particles of the silicon-based material embedded in the metallic material having low capability of forming a lithium compound is formed as illustrated in FIG. 2(b).

In order to deposit the metallic material having low capability of forming a lithium compound in the coating layer 35, the penetration plating conditions are of importance. When in using, for example, copper as a metallic material having low capability of forming a lithium compound and a copper sulfate-based solution as a plating bath, recommended conditions are 30 to 100 g/l in copper concentration, 50 to 200 g/l in sulfuric acid concentration, 30 ppm or lower in chlorine concentration, 30° to 80° C. in bath temperature, and 1 to 100 A/dm² in current density. In using a copper pyrophosphate-based plating bath, recommended conditions are 2 to 50 g/l in copper concentration, 100 to 700 g/l in potassium pyrophosphate concentration, 30° to 60° C. in bath temperature, 8 to 12 in bath pH, and 1 to 10 A/dm² in current density. By appropriately adjusting these electrolysis conditions, the metallic material having low capability of forming a lithium compound is allowed to precipitate through the whole thickness of the coating layer 35. The current density during electrolysis is a particularly important condition. If the current density is too high, metal deposition takes place only on the outer surface of the coating layer 35 but not in the inside.

If necessary, a thin surface layer having microvoids is formed on the plating layer 36. The surface layer is formed by, for example, electroplating. The details of formation of the surface layer with microvoids are described in commonly assigned U.S. patent application Ser. No. 10/522,791 and corresponding JP 3612669B1.

Holes 37 piercing the plating layer 36 are then formed by a prescribed drilling processing. Methods of drilling are not particularly limited. For example, the holes 37 can be formed by laser drilling or mechanical drilling with a needle or a punch. Comparing laser drilling and mechanical drilling, laser drilling is suited for obtaining a negative electrode having good cycle characteristics and charge-discharge efficiency for the following reason. In the case of laser drilling, the metallic material (penetration plating material) melted and re-solidified by a laser beam covers the surface of the particles exposed on the inner wall of the holes 37, so that the particles are protected against exposure and thereby prevented from falling off the wall of the holes 37. Laser drilling is carried out by, for example, directing a laser beam to the plating layer 36. Sand blasting or photoetching using a photoresist may also be used to form the holes 37. The holes 37 are preferably arranged at regular spacing so that the electrode reaction may occur uniformly in the negative electrode.

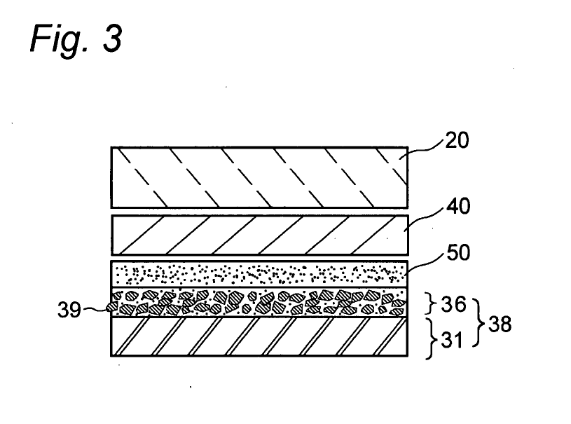

A negative electrode precursor 38 having the particles of the silicon-based material is thus obtained. The particles have not yet had lithium alloyed therewith. The resulting negative electrode precursor 38 is combined with a positive electrode 20 so that the plating layer 36 containing the particulate silicon-based material 39 may face the positive electrode 20 as illustrated in FIG. 3. A separator 40 is interposed between the negative electrode precursor 38 and the positive electrode 20. A metallic lithium layer 50 is disposed between the separator 40 and the negative electrode precursor 38. The space between the positive electrode 20 and the separator 40 is filled with a nonaqueous electrolyte. The nonaqueous electrolyte is also infiltrated between the metallic lithium layer 50 and the separator 40.

The metallic lithium layer 50 can be formed by any method. For example, the metallic lithium layer 50 may be a rolled foil with a prescribed thickness or a lithium layer formed on the surface of the plating layer 36 of the negative electrode precursor 38 by vacuum evaporation.

The thus configured assembly is aged for a predetermined period of time. Meanwhile lithium is allowed to diffuse from the metallic lithium layer 50 into the particulate silicon-based material 39 in the plating layer 36, whereby the particulate silicon-based material 39 has lithium alloyed therewith. As a result of lithium alloying, the plating layer 36 turns to an active material layer 32 containing lithium-alloyed silicon-based material particles 33 and the metallic material 34 present between the particles 33. A negative electrode 30 is thus formed from the negative electrode precursor 38.

The amount of lithium alloyed with the lithium-alloyed particulate silicon-based material 33 is a significant factor influential on the performance of the resulting battery 10. In the present embodiment a preferred degree of lithium alloying is such that the amount of lithium in the lithium-alloyed particulate silicon-based material 33 be in the range of from 5% to 50% based on the theoretical initial charging capacity of silicon for the following reason.

A lithium secondary battery having a negative electrode using silicon as an active material is generally characterized in that a discharge voltage sharply reduces in the final stage of discharge as compared with one using graphite as a negative electrode active material. This is attributed to the remarkable change of negative electrode potential in a region with scarce lithium in the negative electrode having silicon as an active material. The amount of lithium alloyed with silicon is not linearly related to the negative electrode potential. The smaller the amount of lithium, the larger the change in negative electrode potential. If the potential of the negative electrode containing silicon as an active material relative to lithium increases in the final stage of discharge, the battery voltage becomes lower than the operating voltage (cut-off voltage) of existing electronic equipment. This necessitates change of the circuit design of electronic equipment, and improvement in battery energy density cannot be expected. The present invention contemplates designing a battery that can be charged and discharged in a lithium content region in which a stable potential is assured while avoiding a region in which the potential remarkably changes. The lower limit of the amount of lithium to be alloyed is decided from this viewpoint. As regards the upper limit, as the amount of lithium increases, a battery will have an increased capacity, an increased energy density (Wh), and an increased average discharge voltage. On the other hand, a high capacity as expected is not attained because the amount of reversible lithium is limited in relation to the active material for positive electrode such as LiCoO₂. The upper limit of the amount of lithium to be alloyed is decided from this standpoint. By alloying lithium with silicon within the thus decided range, a battery with an increased capacity and energy density level can be designed within the range of operating voltage for existing electronic equipment.

A small amount of water can often enter a nonaqueous electrolyte secondary battery during the production. Water in a battery reacts with a nonaqueous electrolyte to decompose it, which causes an increase of initial irreversible capacity. In the present embodiment, by controlling the degree of lithium alloy within the recited range, water in the battery is consumed through reaction with lithium without inducing the problem of lithium depletion. Thus, to control the amount of lithium to be alloyed with the recited range not only achieves high capacity and high energy density but also reduces initial irreversible capacity. In addition, improvement on charge/discharge efficiency in each charge/discharge cycle (cycle characteristics) is also obtained.

Apart from water, a trace amount of oxygen is unavoidably incorporated into the current collector or active material. Oxygen forms a compound with lithium on charging and discharging. Because Li—O has relatively strong bond strength, formation of an Li—O compound reduces the amount of reversibly usable lithium. That is, the initial irreversible capacity increases. In the present invention, oxygen in the battery is consumed by metallic lithium. It follows that the initial irreversible capacity is reduced and that the charge/discharge efficiency in every charge/discharge cycle (cycle characteristics) is improved.

To further enhance the above described effects, it is preferred that the amount of lithium to be alloyed with the particles 33 be 10% to 40%, still preferably 20% to 40%, even still preferably 25% to 40%, based on the theoretical initial charge capacity of silicon present in the particles 33. Theoretically, silicon is capable of alloying lithium therewith to such an extent as to create the state represented by compositional formula: SiLi_{4.4}. When the amount of lithium alloyed is 100% of the theoretical initial charge capacity of silicon, this means that lithium is alloyed with silicon to such an extent as to create the state represented by compositional formula: SiLi_{4.4}.

In the case where the positive electrode 20 constituting the battery 10 together with the negative electrode 30 has a lithium-containing active material for positive electrode, the amount of lithium to be alloyed in the particles 33 relates to the amount of the active material for positive electrode. Specifically, in assembling the battery 10 using the negative electrode 30 of the present embodiment and a positive electrode 20 having a lithium-containing active material for positive electrode, lithium alloying is preferably performed so as to satisfy formula (1):

4.4A−B≧C (1)

where A is the number of moles of silicon in the member containing a silicon-based material; B is the number of moles of lithium in the lithium-containing active material for positive electrode; and C is the number of moles of lithium alloyed.

The degree of lithium alloying varies with the time and temperature of aging. To accomplish efficient alloying of a predetermined amount of lithium, the aging time is preferably 0.1 to 120 hours, still preferably 0.5 to 80 hours, and the aging temperature is preferably 10° to 80° C., still preferably 20° to 60° C.

The aging is preferably carried out until the metallic lithium layer 50 is completely alloyed within the particulate silicon-based material 39. If the metallic lithium layer 50 partly remains, it may serve as a precipitation site on which lithium can grow dendritically through repetition of charge/discharge cycles. Lithium dendrite causes internal short-circuit of the battery 10.

The amount of the metallic lithium layer 50 is therefore decided in relation to the total amount of silicon of the particulate silicon-based material 39 in the plating layer 36. Specifically, the amount of the metallic lithium layer 50 is preferably such that the amount of lithium contained in the particles 33 having lithium alloyed therewith may be within the above recited preferred range. With the amount of the metallic lithium layer 50 being so adjusted, complete alloying of the metallic lithium layer 50 into the silicon-based material particles 39 then results in alloying of the recited amount of lithium.

The particles 33, i.e., silicon-based material particles 39 having lithium alloyed therewith, have an increased volume over that of the particles 39 (before lithium alloying) as a result of expansion due to lithium alloying. According as the metallic lithium layer 50 is being alloyed with the particles 39 and decreasing in volume, the decrease in volume is turned to a volume gain of the particles 33.

The battery 10 of the structure shown in FIG. 1 is thus obtained. The resulting battery 10 has an advantage of reduced drop of battery voltage even in the final stage of discharge. That is, the battery 10 is capable of discharge in a high voltage range. This enables batteries to improve their capacity without altering the kind of the active material for positive electrode used in existing nonaqueous secondary batteries and without changing the operating voltage of existing electronic equipment (i.e., no need to re-design the circuit of the existing devices).

The battery 10 thus obtained may have the shape of button, cylinder or prism. Whatever shape the battery may have, the particulate silicon-based material 33 having lithium alloyed therewith is effectively prevented from falling off since the metallic material 34 having low capability of forming a lithium compound is present between the silicon-based material particles 33 having lithium alloyed therewith. While, in general, cylindrical or prismatic batteries are more liable to suffer fall-off of the active material than button type batteries, fall-off of the particles 33 hardly occurs in the battery of the present embodiment even with a cylindrical or prismatic shape. Accordingly, the structure of the battery 10 according to the present embodiment is particularly effective when applied to a jelly-roll type battery having a cylindrical or prismatic configuration that is obtained by winding the negative electrode 30, positive electrode 20, and separator 40 disposed therebetween into a spiral-wound assembly and putting the assembly into a battery case.

While the present invention has been described with respect to its preferred embodiment, it should be understood that the invention is not limited thereto. For instance, while the negative electrode 30 of the above embodiment has the active material layer 32 on one side of the current collector 31, the active material layer 32 may be formed on both sides of the current collector 31.

While the negative electrode 30 of the above embodiment has the current collector 31, the current collector 31 may not be used as long as the active material layer 32 alone has sufficient strength and current collecting performance. In such a case, a surface layer may be provided on at least one side of the active material layer 32 to enhance the strength or current collecting performance. Specific examples of negative electrode structures free of the current collector 31 are described, e.g., in commonly assigned U.S. patent application Ser. No. 10/522,791 and corresponding JP 3612669B1.

While the active material layer 32 of the negative electrode 30 according to the above embodiment is formed by coating a slurry containing the particulate silicon-based material, a thin film of the silicon-based material formed by various thin film formation techniques may be used as well. Such an active material layer is exemplified by the one disclosed in JP 2003-17040A. A sintered body of the particulate silicon-based material is also usable as an active material layer. Such an active material layer is exemplified by the one described in U.S. 2004/0043294A1.

### EXAMPLE

The present invention will now be illustrated in greater detail with reference to Example, but it should be understood that the invention is not limited thereto.

### Example 1

A 10 μm thick rolled copper foil as a current collector was cleaned with an acid at room temperature for 30 seconds and washed with pure water for 15 seconds. A slurry of Si particles was applied to the current collector to a thickness of 30 μm to form a coating layer. The particles had a median particle size D₅₀ of 2 μm. The slurry contained the particles, acetylene black, and styrene-butadiene rubber at a weight ratio of 98:2:1.7.

The current collector having the coating layer was immersed in a Watt's bath having the following composition, and the coating layer was penetration-plated with nickel by electrolysis under conditions of a current density of 5 A/dm², a bath temperature of 50° C., and a bath pH of 5. A nickel electrode was used as an anode, and a direct current power source was used. The current collector was taken out of the plating bath, washed with pure water for 30 seconds, and dried in the atmosphere.

NiSO₄.6H₂O: 250 g/l

NiCl₂.6H₂O: 45 g/l

H₃BO₄: 30 g/l

The carrier foil was taken out of the plating bath, washed with water, and irradiated on its plating layer side with YAG laser light to form holes piercing the plating layer in a regular pattern. The holes had a diameter of 24 μm and a pitch of 100 μm (10000 holes/cm²). The open area ratio was 4.5%. There was thus obtained a negative electrode precursor.

LiCoO₂ was used as an active material for positive electrode. A positive electrode was prepared by coating LiCoO₂ on a 20 μm thick Al foil to adapt the thickness of LiCoO₂ layer to the capacity of 4 mAh/cm². A polyethylene porous film was used as a separator. A solution of LiPF₆ in a 1:1 (by volume) mixed solvent of ethylene carbonate and dimethyl carbonate was used as a nonaqueous electrolyte.

The plating layer side of the negative electrode precursor and the positive electrode were faced to each other with the separator interposed therebetween. A 30 μm thick rolled lithium foil was interposed between the negative electrode precursor and the separator. A second separator was placed on the outer side of the positive electrode. The amount of the metallic lithium was 40% of the theoretical initial charge capacity of silicon.

The resulting assembly was rolled with the second separator inside to make a spiral wound assembly, which was put into a cylindrical battery case. The nonaqueous electrolyte was injected into the case, and the case was closed. The system was aged at 60° C. for 8 hours, whereby lithium was alloyed with the Si particles. The amount of lithium alloyed was 40% based on the theoretical initial charge capacity of silicon. The lithium content in the active material for positive electrode was 50% based on the theoretical initial charge capacity of silicon. Accordingly, the amount of lithium alloyed satisfied formula (1). As a result of lithium alloying, the rolled lithium foil disappeared. There was thus obtained a lithium secondary battery.

### Comparative Example 1

A lithium secondary battery was obtained in the same manner as in Example 1, except for using a negative electrode prepared by coating carbon powder to the copper foil to a thickness of 80 μm and using no rolled lithium foil.

### Comparative Example 2

A lithium secondary battery was obtained in the same manner as in Example 1, except that the rolled lithium foil was not disposed between the negative electrode precursor and the separator.

### Evaluation:

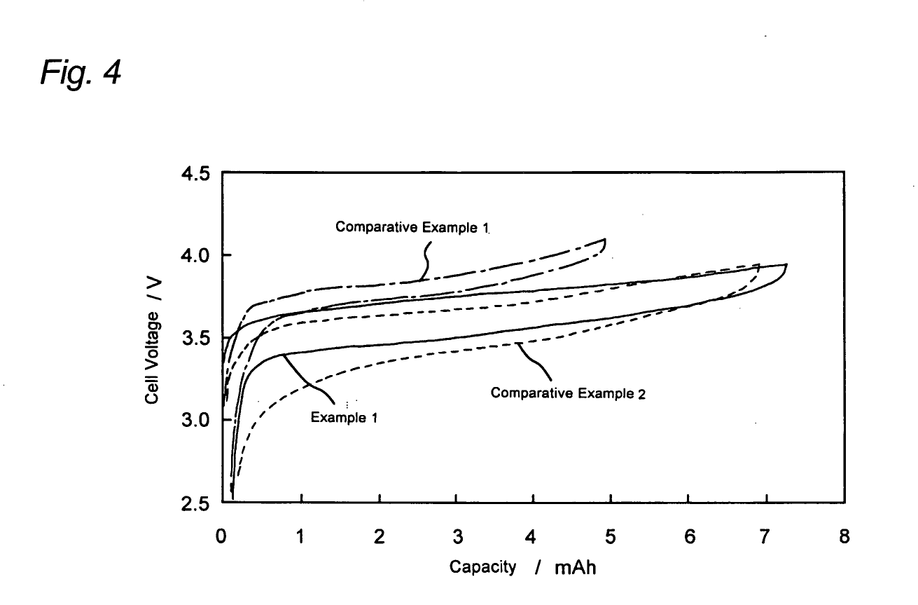

The resulting batteries were evaluated for charge and discharge characteristics. FIG. 4 shows the charge/discharge curves of the second cycle. As is apparent from the results, the battery of Example 1 shows no voltage drop in the final stage of discharge, keeping a voltage of 3 V. It is also seen that the battery of Example 1 achieves a high capacity. In contrast, the battery of Comparative Example 1 has a low capacity, and the battery of Comparative Example 2, while having a high capacity, shows a voltage drop in the final stage of discharge.

### INDUSTRIAL APPLICABILITY

As described, according to the present invention, lithium can easily be alloyed with a silicon-based material. By limiting the amount of lithium alloyed to a specific range, in particular, a battery capacity is increased without the need of altering the kind of the active material for positive electrode used in existing nonaqueous secondary batteries.

1. A process of producing a nonaqueous secondary battery comprising the steps of:
disposing a separator between a member containing a silicon-based material and a positive electrode, together with interposing a metallic lithium layer between the separator and the member to obtain an assembly; and
aging the resulting assembly for a prescribed period of time to alloy lithium with the silicon-based material.

2. The process of producing a nonaqueous secondary battery according to claim 1, wherein lithium is alloyed to a degree such that the amount of lithium in the silicon-based material is 5% to 50% based on the theoretical initial charge capacity of silicon.

3. The process of producing a nonaqueous secondary battery according to claim 1, wherein the positive electrode has a lithium-containing active material for positive electrode, and lithium is alloyed to a degree satisfying formula (1):
4.4A−B≧C (1)
where A is the number of moles of silicon in the member containing the silicon-based material; B is the number of moles of lithium in the lithium-containing active material for positive electrode; and C is the number of moles of lithium to be alloyed.

4. The process of producing a nonaqueous secondary battery according to claim 1, wherein the aging is carried out at 10° to 80° C.

5. The process of producing a nonaqueous secondary battery according to claim 1, wherein the aging is carried out until the metallic lithium layer is completely alloyed.

6. The process of producing a nonaqueous secondary battery according to claim 1, wherein the silicon-based material is in the form of particles, and a metallic material having low capability of forming a lithium compound is present between the particles.
